(19) United States
(12) Patent Application Publication
(10) Pub. No.: US 2012/0285700 A1
(43) Pub. Date: Nov. 15, 2012

(54) Harvesting By-Passed Resource

(76) Inventor: George R Scott, (US)

(21) Appl. No.: 13/463,299

(22) Filed: May 3, 2012

(30) Foreign Application Priority Data
May 12, 2011 (CA) 2,740,158

(51) Int. Cl. E21B 43/00; G06G 7/48; E21B 7/00

(52) U.S. Cl. 166/369; 175/57; 166/57; 703/10

(57) ABSTRACT

A method is provided for drilling a well in a reservoir. The method includes planning a well trajectory for a serpentine well that accesses a bypassed hydrocarbon in the reservoir. The serpentine well is drilled using lateral displacements and vertical displacements to follow the base in the reservoir. The serpentine well is completed with perforations in regions comprising the bypassed hydrocarbon.

### CROSS-REFERENCE TO RELATED APPLICATIONS

This application claims the benefit of Canadian patent application number 2,740,158 filed on May 12, 2011 entitled HARVESTING BY-PASSED RESOURCE, the entirety of which is incorporated herein.

### FIELD

The present techniques relate to the use of in-fill wells. Specifically, techniques are disclosed for designing serpentine wells to maximize the recovery of by-passed resource.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Modern society is greatly dependant on the use of hydrocarbons for fuels and chemical feedstocks. Hydrocarbons are generally found in subsurface rock formations that can be termed “reservoirs.” Removing hydrocarbons from the reservoirs depends on numerous physical properties of the rock formations, such as the permeability of the rock containing the hydrocarbons, the ability of the hydrocarbons to flow through the rock formations, and the proportion of hydrocarbons present, among others.

Easily harvested sources of hydrocarbon are dwindling, leaving less accessible sources to satisfy future energy needs. However, as the costs of hydrocarbons increase, these less accessible sources become more economically attractive. For example, the harvesting of oil sands to remove hydrocarbons has become more extensive as it has become more economical. The hydrocarbons harvested from these reservoirs may have relatively high viscosities, for example, ranging from 8 API, or lower, up to 20 API, or higher. Accordingly, the hydrocarbons may include heavy oils, bitumen, or other carbonaceous materials, collectively referred to herein as “heavy oil,” which are difficult to recover using standard techniques.

Several methods have been developed to remove hydrocarbons from oil sands. For example, strip or surface mining may be performed to access the oil sands, which can then be treated with hot water or steam to extract the oil. However, deeper formations may not be accessible using a strip mining approach. For these formations, a well can be drilled to the reservoir and steam, hot air, solvents, or combinations thereof, can be injected to release the hydrocarbons. The released hydrocarbons may then be collected by the injection well or by other wells and brought to the surface.

A number of techniques have been developed for harvesting heavy oil from subsurface formations using thermal recovery techniques. Thermal recovery operations are used around the world to recover liquid hydrocarbons from both sandstone and carbonate reservoirs. These operations include a suite of steam based in situ thermal recovery techniques, such as cyclic steam stimulation (CSS), steam flooding and steam assisted gravity drainage (SAGD) as well as surface mining and their associated thermal based surface extraction techniques.

For example, CSS techniques includes a number of enhanced recovery methods for harvesting heavy oil from formations that use steam heat to lower the viscosity of the heavy oil. These steam assisted hydrocarbon recovery methods are described in U.S. Pat. No. 3,292,702 to Boberg, and U.S. Pat. No. 3,739,852 to Woods, et al., among others. CSS and other steam flood techniques have been utilized worldwide, beginning in about 1956 with the utilization of CSS in the Mene Grande field in Venezuela and steam flood in the early 1960s in the Kern River field in California.

The CSS process may raise the steam injection pressure above the formation fracturing pressure to create fractures within the formation and enhance the surface area access of the steam to the heavy oil, although CSS may also be practiced at pressures that do not fracture the formation. The steam raises the temperature of the heavy oil during a heat soak phase, lowering the viscosity of the heavy oil. The injection well may then be used to produce heavy oil from the formation. The cycle is often repeated until the cost of injecting steam becomes uneconomical, for instance if the cost is higher than the money made from producing the heavy oil. However, successive steam injection cycles reenter earlier created fractures and, thus, the process becomes less efficient over time. CSS is generally practiced in vertical wells, but systems are operational in horizontal wells. U.S. Pat. No. 6,158,510 to Bacon, et al., discloses a liner design that successfully addresses the complications due to localized fracturing and steam entry and the lack of steam flow control along the long length of the horizontal well bore, as discussed further below.

Solvents may be used in combination with steam in CSS processes, such as in mixtures with the steam or in alternate injections between steam injections. These techniques are described in U.S. Pat. No. 4,280,559 to Best, U.S. Pat. No. 4,519,454 to McMillen, and U.S. Pat. No. 4,697,642 to Vogel, among others.

Cyclic enhanced recovery techniques have been developed that are not based on thermal methods. For example, U.S. Pat. No. 6,769,486 to Lim, et al., discloses a cyclic solvent process for heavy oil production. In the process, a viscosity reducing hydrocarbon solvent is injected into a reservoir at a pressure sufficient to keep the hydrocarbon solvent in a liquid phase. The injection pressure may also be sufficient to cause dilation of the formation. The hydrocarbon solvent is allowed to mix with the heavy oil at the elevated pressure. The pressure in the reservoir can then be reduced to allow at least a portion of the hydrocarbon solvent to flash, providing a solvent gas drive to assist in removing the heavy oil from the reservoir. The cycles may be repeated as long as economical production is achieved.

Another group of techniques is based on a continuous injection of steam through a first well to lower the viscosity of heavy oils and a continuous production of the heavy oil from a lower-lying second well. Such techniques may be termed “steam assisted gravity drainage” or SAGD. Various embodiments of the SAGD process are described in Canadian Patent No. 1,304,287 to Butler and its corresponding U.S. Pat. No. 4,344,485.

In SAGD, two horizontal wells are completed into the reservoir. The two wells are first drilled vertically to different depths within the reservoir. Thereafter, using directional drilling technology, the two wells are extended in the horizontal direction that result in two horizontal wells, vertically spaced from, but otherwise vertically aligned with the other. Ideally, the production well is located above the base of the reservoir but as close as practical to the bottom of the reservoir, and the injection well is located vertically 10 to 30 feet (3 to 10 meters) above the horizontal well used for production.

The upper horizontal well is utilized as an injection well and is supplied with steam from the surface. The steam rises from the injection well, permeating the reservoir to form a vapor chamber that grows over time towards the top of the reservoir, thereby increasing the temperature within the reservoir. The steam, and its condensate, raise the temperature of the reservoir and consequently reduce the viscosity of the heavy oil in the reservoir. The heavy oil and condensed steam will then drain downward through the reservoir under the action of gravity and may flow into the lower production well, whereby these liquids can be pumped to the surface. At the surface of the well, the condensed steam and heavy oil are separated, and the heavy oil may be diluted with appropriate light hydrocarbons for transport by pipeline.

A number of variations of the SAGD process have been developed in an attempt to increase the productivity of the process. Such processes may include new well placement techniques and tools used to enhance production of the heavy oil. In other variations, extensions similar to those used in CSS, such as including solvents in the process, have been made. For example, U.S. Pat. No. 6,230,814 to Nasr, et al., teaches how the SAGD process can be further enhanced through the addition of small amounts of solvent to the injected steam. In addition, Butler, et al., “A New Process (Vapex) for Recovering Heavy Oils,” JCPT, Vol. 30, No. 1, 97-106, January-February 1991, teaches how solvent can be used instead of steam in a gravity drainage based recovery process to recover heavy oil from a subterranean reservoir.

Various well placement techniques have been developed to attempt improvements in SAGD productivity. For example, U.S. Pat. No. 5,860,475 to Ejiogu, et al. discloses a drainage process using a steam drive in a mixture of well types. The process can be used in a heavy oil reservoir having a plurality of laterally separated, generally vertical wells whose use have left the reservoir characterized by a heated depletion zone, a channel, voids, or mobility and communication. The technique can be performed by drilling a horizontal well laterally between at least two of the vertical wells and at a depth within the lower part of the reservoir. The horizontal well can have an opening along the horizontal section. Steam is injected through the two vertical wells to establish thermal communication with the horizontal well, and the combination of steam drive and gravity drainage is used to recover heavy oil from the reservoir through the horizontal well.

One well placement technique involves the use of in-fill wells to access materials located between SAGD injection and production well pairs. U.S. Pat. No. 6,257,334 to Cyr, et al., discloses the use of a pair of vertically spaced, parallel, co-extensive, horizontal injection and production wells and a laterally spaced, horizontal offset well are provided in a subterranean reservoir containing heavy oil. Fluid communication is established across the span of formation extending between the pair of wells. SAGD is then practiced by injecting steam through the injection well and producing heavy oil and steam condensate through the production well. CSS is practiced at the offset well. The steam chamber developed at the offset well tends to grow toward the steam chamber of the SAGD pair, thereby accelerating development of communication between the SAGD pair and the offset well. This process is continued until fluid communication is established between the injection well and the offset well. The offset well is then converted to producing heavy oil and steam condensate as steam continues to be injected through the injection well.

Similarly, Canadian Patent No. 2,591,498 and corresponding U.S. Pat. No. 7,556,099 to Arthur, et al. discloses a recovery process that utilizes in-fill wells. In the method, a first injector-producer well pair is operated under a substantially gravity-controlled recovery process, forming a first mobilized zone. A second injector-producer well pair is also operated under a substantially gravity-controlled recovery process, forming a second mobilized zone. An in-fill well is provided in a bypassed region, formed between the adjacent well pairs. When the first mobilized zone and the second mobilized zone merge to form a common mobilized zone, the in-fill well can be operated to establish fluid communication between the in-fill well and the common mobilized zone. Accordingly, the in-fill well and the adjacent well pairs may be operated under a substantially gravity-controlled recovery process to recover heavy oil from the in-fill well.

In another example of the use of in-fill wells, U.S. Patent Application Publication No. 2009/0288827 by Coskuner, filed Nov. 26, 2009, discloses a process for recovering heavy oil from oil sands. In the process, CSS is first used in a series of horizontal wells in the reservoir. SAGD is then used with a vertically-spaced horizontal well pair in which one well in each well pair is part of the series of wells to which CSS was applied, and oil is produced from at least one single well in the series of wells. In this case, each single well is adjacent to and offset from at least one of the well pairs. The method can then include applying a SAGD injection to an injection well of each well pair and producing oil from a production well of each well pair and from the single well.

Specific tools have been developed for SAGD, for example, to lower the amount of sand entrained in the production stream. For example, U.S. Pat. No. 6,158,510 and corresponding Canadian Patent No. 2,219,513 to Bacon, et al., disclose a system for enhancing steam distribution and for reducing the production of particulate matter using a horizontal well. The system has a base pipe with a limited number of spaced-apart perforations. The spaced-apart perforations are sized and located to uniformly distribute steam in the reservoir. Each hole has a collar to deflect the steam into an annulus between the base pipe and a wire-wrap screen section. This assists in avoiding erosion and deterioration of the wire-wrap screen section, which is required in the production phase. The wire-wrap screen section filters particulate matter from produced hydrocarbons. The open area in the base pipe is lower than used in conventional methods, so that at the design injection rates, the pressure drop through the spaced-apart holes is larger than the pressure drop along the base pipe. During hydrocarbon fluid production, the pressure drop from the reservoir to the spaced-apart holes is low due to the presence of the wire-wrap screens.

A number of developments have focused on using solvents to lower the temperature of the extraction process. For example, Canadian Patent No. 2,243,105 to Mokrys discloses a non-thermal vapor extraction method for the recovery of hydrocarbons from deep, high pressure hydrocarbon reservoirs. The reservoirs may have been previously exploited by cold flow or may be virgin deposits. The target reservoirs are underlain by active aquifers. A mixture of a light hydrocarbon vapor solvent, such as ethane, propane, and butane, with reservoir natural gas is adjusted so that the dewpoint of the light hydrocarbon solvent matches the temperature and pressure conditions in the reservoir. The produced gas is analyzed for the solvent component, and enriched with the required amount of recycled solvent to match the dewpoint. The gas is then reintroduced into the reservoir as an injection gas. Both the recovered solvent and free gas are continuously circulated through the reservoir.

The extraction can be accomplished by employing pairs of parallel horizontal injection/production wells, in a similar fashion to SAGD. The extraction may also be performed by converting existing vertical or inclined cold production wells into injectors and adding horizontal production wells. The horizontal production wells are in communication with the reservoir fluids through slotted liners to lower sand entrainment. The large contact area required between the solvent and the hydrocarbons for an economically viable operation is achieved by using high permeability zones of the reservoir, such as fractures, channels left behind after cold flow production, or aquifers. The horizontal production wells may be located at the bottom of the pay zone, just above the aquifer. The active aquifer between the injection wells may also be receded deeper into the reservoir to control water production.

Similarly, Canadian Patent No. 2,494,391 and Canadian Patent Application Publication No. 2,584,712 by Chung, et al., disclose a cold solvent-based extraction method for extracting heavy oil from a reservoir. The method involves forming a solvent fluid chamber by solvent fluid injection and heavy oil production using combinations of horizontal and/or vertical injection wells. The combination may increase the recovery of heavy oil contained in a reservoir.

Solvents may also be used in concert with steam addition to increase the efficiency of the steam in removing the heavy oils. U.S. Pat. No. 6,230,814 to Nasr, et al., discloses a method for enhancing heavy oil mobility using a steam additive. The method included injecting steam and an additive into the formation. The additive includes a non-aqueous fluid, selected so that the evaporation temperature of the non-aqueous fluid is within about ±150° C. of the steam temperature at the operating pressure. Suitable additives include C₁ to C₂₅ hydrocarbons. At least a portion of the additive condenses in the formation. The mobility of the heavy oil obtained with the steam and solvent combination is greater than that obtained using steam alone under substantially similar formation conditions.

Heavy oil recovery techniques do not have to be based on mobilizing only the hydrocarbon. In some techniques, the entire formation may be produced, the heavy oil recovered, and the cleaned material reinjected as a backfill slurry. For example, International Patent Application No. WO/2007/050180, by Yale and Herbolzheimer, discloses such a process. The method includes accessing the formation from two or more locations. The formation may include heavy oil and one or more solids. The formation is pressurized to a pressure sufficient to relieve the overburden stress. A differential pressure is created between the two or more locations to provide one or more high pressure locations and one or more low pressure locations. The differential pressure is controlled to mobilize at least a portion of the solids and a portion of the heavy oil in the formation. The mobilized solids and heavy oil then flow toward the one or more low pressure locations to provide a slurry comprising heavy oil, water and one or more solids. The slurry comprising the heavy oil and solids is flowed to the surface where the heavy oil is recovered from the one or more solids. The one or more solids are recycled to the formation, for example, as backfill.

The techniques discussed above may leave a substantial remainder of hydrocarbons in the reservoir. For example, in-fill wells in SAGD are generally designed in a similar fashion to the lower, drainage wells in SAGD having a horizontal run placed between two SAGD pairs.

### SUMMARY

An embodiment of the present techniques provides a method for improving recovery from a subsurface hydrocarbon reservoir. The method includes identifying a region within the reservoir that comprises significant accumulations of unswept hydrocarbons and accessing the region by a serpentine well, wherein the placement and completion of the serpentine well is optimized to maximize the recovery of the unswept hydrocarbons. Fluid communication is established between the serpentine well and a current swept region of the reservoir. Production of an injected mobilizing fluid used in the hydrocarbon recovery process.

Identifying the region may include creating a geologic model of the reservoir and using the geologic model to locate the unswept hydrocarbons. The geologic model may include open hole log data, cased hole log data, core data, recovery process well trajectories, 2D seismic data, 3D seismic data, or other remote surveying data, or any combinations thereof.

Accessing the region may include designing the serpentine well with a vertical placement, lateral placement, or both, that changes to intercept the region near a base within the reservoir. Further, the serpentine well may be completed so that the openings in the serpentine well are placed in the unswept portions of the reservoir having a coldest temperature, a highest induction log signature, or both. Sections in warmer regions or having lower induction log signatures may be completed with blank pipe or obstructing openings to prevent flow. The serpentine well may be geosteered to follow the base of the portion of the reservoir containing resource acceptable for exploitation by the recovery process.

Minimizing production of the injected mobilizing fluid may include obstructing portions of a liner in the serpentine well. One or more production wells may be blocked to lower production of the injected mobilizing fluid. Further, portions of a liner in a production well may be blocked. A liner with inflow control devices may be used to restrict the production of the injected mobilizing fluid.

Active techniques may be used to minimize the production of an injected mobilizing fluid. For example, the bottom hole temperature, the bottom hole pressure, the production rates of the injected mobilizing fluid at the surface, or any combinations of these may be estimated from measurements or models. The production rates, injection rates, or both, of the mobilizing fluid, may be adjusted based, at least in part, on data estimated.

Each of two or more unswept regions of the reservoir may be accessed by an associated separate portion of the serpentine well. For example, each unswept region may be sequentially depleted through the associated separate portion of the serpentine well and, when finished, the associated separate portion can be blocked when it is not used to produce hydrocarbons from the associated unswept region. Unused perforations of the trajectory of the serpentine well may be blocked with a scab liner.

The serpentine well deeper than existing production wells. This may result in shutting in an existing production wells. Further, a liner in an existing production well may be obstructed for at least a portion of a trajectory.

The serpentine well may be drilled once an existing recovery process has achieved at least 50% of its anticipated recovery. In some cases, the serpentine well may be drilled once an existing recovery process has achieved at least 10% of its anticipated recovery.

Another embodiment provides a system for harvesting bypassed resources in a reservoir. The system includes a gravity drainage system configured to drain a first portion of resources from a reservoir and a serpentine well, wherein the serpentine well is directionally drilled to follow a base of the reservoir, wherein the base substantially delineates the resources that are recoverable, and wherein the serpentine is configured to harvest a second portion of resources from the reservoir.

The gravity drainage system may include a number of steam assisted gravity drainage (SAGD) well pairs drilled in a substantially horizontal fashion through the reservoir. In some embodiments, the gravity drainage system may include a number of steamflood wells, a number of mature cyclic steam stimulation (CSS) wells, or combinations thereof.

Any number of injected mobilizing fluids may be used in the gravity drainage processes. For example, the gravity drainage system may include a number of injectant-assisted gravity-drainage well pairs drilled in a substantially horizontal fashion through the reservoir, wherein the injectant comprises a solvent, steam, hot water, or any combinations thereof. Further, the gravity drainage system may include a number of injectant wells, wherein the injectant comprises a solvent, steam, hot water, gas, or any combinations thereof. The gravity drainage system may also include a number of mature cyclic stimulation wells, wherein an injectant is used to mobilize the resources, and wherein the injectant comprises a solvent, steam, hot water, or any combinations thereof.

The serpentine well may be geosteered during drilling. For example, the serpentine well may be directionally drilled to access a plurality of regions comprising bypassed hydrocarbons. This may lead to the serpentine well passing below a production well. Perforations in a trajectory of a production well in the gravity drainage system that overlies the serpentine well may be plugged. Similarly, perforations in a trajectory of the serpentine well may be blocked when not used to harvest the second portion of resources from the reservoir. A geologic model may be configured to identify the second portion, e.g., bypassed, resources.

Another embodiment provides a method for drilling a well in a reservoir. The method includes planning a well trajectory for a serpentine well that accesses a bypassed hydrocarbon in the reservoir and drilling the serpentine well using lateral displacements and vertical displacements to follow a base of a payzone in the reservoir. The serpentine well can be completed with perforations in regions comprising the bypassed hydrocarbon.

The method may use numerous types of information to identify the locations of bypassed resources. For example, the method may include collecting open hole log data, cased hole log data, core data, recovery process well trajectories, 2D seismic data, 3D seismic data, or other remote surveying data, or any combinations thereof. A geologic model may be constructed from the data collected. Well trajectories that need to be blocked to minimize production of injected mobilizing fluids may be identified. Similarly, productions wells that need to be partially or fully blocked to minimize production of injected mobilizing fluids may be identified.

### DESCRIPTION OF THE DRAWINGS

The advantages of the present techniques are better understood by referring to the following detailed description and the attached drawings, in which:

FIG. 1 is a drawing of a SAGD process, showing an additional serpentine recovery well;

FIGS. 2(A) and (B) are East-West and North-South cross-sections of a portion of a geologic deposit, respectively;

FIGS. 3(A) and (B) are the cross sectional views of the geologic deposit of FIG. 2, with the addition of three SAGD well pairs, each well pair nominally 100 meters (300 feet) from its neighbour;

FIGS. 4(A), (B), and (C) are East-West cross-sectional views of the geologic deposit, representing the northern, middle and southern portions of the North-South cross sectional view of FIG. 2(B), respectively;

FIGS. 5(A), (B), and (C) are cross-sectional views illustrating the placement of standard in-fill wells in the cross-sectional view of FIGS. 4(A), (B), and (C), respectively;

FIGS. 6(A), (B), and (C) are cross-sectional views illustrating the placement of serpentine wells in the cross-sectional view of FIGS. 4(A), (B), and (C), respectively;

FIG. 7 is top view of the reservoir illustrating the trajectories of the serpentine well as they access the bypassed hydrocarbons in the unswept regions;

FIGS. 8(A), (B), and (C) are cross-sectional views illustrating the continued growth of the depleted resource in the cross-sectional views of FIGS. 4(A), (B), and (C), respectively, after the start-up of the serpentine wells; and

FIG. 9 is a process flow diagram of a method for completing in-fill wells that access bypassed resources.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the term “base” indicates a lower boundary of the resources in a reservoir that are practically recoverable, by a gravity-assisted drainage technique, for example, using an injected mobilizing fluid, such as steam, solvents, hot water, gas, and the like. The base may be considered a lower boundary of the payzone. The lower boundary may be an impermeable rock layer, including, for example, granite, limestone, sandstone, shale, and the like. The lower boundary may also include layers that, while not completely impermeable, impede the formation of fluid communication between a well on one side and a well on the other side. Such layers may include broken shale, mud, silt, and the like. The resources within the reservoir may extend below the base, but the resources below the base may not be recoverable with gravity assisted techniques.

“Bitumen” is a naturally occurring heavy oil material. Generally, it is the hydrocarbon component found in oil sands. Bitumen can vary in composition depending upon the degree of loss of more volatile components. It can vary from a very viscous, tar-like, semi-solid material to solid forms. The hydrocarbon types found in bitumen can include aliphatics, aromatics, resins, and asphaltenes. A typical bitumen might be composed of:

19 wt. % aliphatics (which can range from 5 wt. %-30 wt. %, or higher);

19 wt. % asphaltenes (which can range from 5 wt. %-30 wt. %, or higher);

30 wt. % aromatics (which can range from 15 wt. %-50 wt. %, or higher);

32 wt. % resins (which can range from 15 wt. %-50 wt. %, or higher); and

some amount of sulfur (which can range in excess of 7 wt. %).

In addition bitumen can contain some water and nitrogen compounds ranging from less than 0.4 wt. % to in excess of 0.7 wt. %. The metals content, while small, must be removed to avoid contamination of the product synthetic crude oil (SCO). Nickel can vary from less than 75 ppm (part per million) to more than 200 ppm. Vanadium can range from less than 200 ppm to more than 500 ppm. The percentage of the hydrocarbon types found in bitumen can vary. As used herein, the term “heavy oil” includes bitumen, as well as lighter materials that may be found in a sand or carbonate reservoir.

As used herein, two locations in a reservoir are in “fluid communication” when a path for fluid flow exists between the locations. For example, the establish of fluid communication between a lower-lying serpentine well and a higher injection well may allow material mobilized from a steam chamber above the injection well to flow down to the serpentine well from collection and production. As used herein, a fluid includes a gas or a liquid and may include, for example, a produced hydrocarbon, an injected mobilizing fluid, or water, among other materials.

As used herein, a “cyclic recovery process” uses an intermittent injection of injected mobilizing fluid selected to lower the viscosity of heavy oil in a hydrocarbon reservoir. The injected mobilizing fluid may include steam, solvents, gas, water, or any combinations thereof. After a soak period, intended to allow the injected material to interact with the heavy oil in the reservoir, the material in the reservoir, including the mobilized heavy oil and some portion of the mobilizing agent may be harvested from the reservoir. Cyclic recovery processes use multiple recovery mechanisms, in addition to gravity drainage, early in the life of the process. The significance of these additional recovery mechanisms, for example dilation and compaction, solution gas drive, water flashing, and the like, declines as the recovery process matures. Practically speaking, gravity drainage is the dominant recovery mechanism in all mature thermal, thermal-solvent and solvent based recovery processes used to develop heavy oil and bitumen deposits, such as steam assisted gravity drainage (SAGD). For this reason the approaches disclosed here are equally applicable to all recovery processes in which at the current stage of depletion gravity drainage is the dominant recovery mechanism.

“Facility” as used in this description is a tangible piece of physical equipment through which hydrocarbon fluids are either produced from a reservoir or injected into a reservoir, or equipment which can be used to control production or completion operations. In its broadest sense, the term facility is applied to any equipment that may be present along the flow path between a reservoir and its delivery outlets. Facilities may comprise production wells, injection wells, well tubulars, wellhead equipment, gathering lines, manifolds, pumps, compressors, separators, surface flow lines, steam generation plants, processing plants, and delivery outlets. In some instances, the term “surface facility” is used to distinguish those facilities other than wells.

“Heavy oil” includes oils which are classified by the American Petroleum Institute (API), as heavy oils or extra heavy oils. In general, a heavy oil has an API gravity between 22.3° (density of 920 kg/m3 or 0.920 g/cm³) and 10.0° (density of 1,000 kg/m3 or 1 g/cm³). An extra heavy oil, in general, has an API gravity of less than 10.0° (density greater than 1,000 kg/m3 or greater than 1 g/cm³). For example, a source of heavy oil includes oil sand or bituminous sand, which is a combination of clay, sand, water, and bitumen. The thermal recovery of heavy oils is based on the viscosity decrease of fluids with increasing temperature or solvent concentration. Once the viscosity is reduced, the mobilization of fluids by steam, hot water flooding, or gravity is possible. The reduced viscosity makes the drainage quicker and therefore directly contributes to the recovery rate.

A “hydrocarbon” is an organic compound that primarily includes the elements hydrogen and carbon, although nitrogen, sulfur, oxygen, metals, or any number of other elements may be present in small amounts. As used herein, hydrocarbons generally refer to components found in heavy oil, or other oil sands.

“Permeability” is the capacity of a rock to transmit fluids through the interconnected pore spaces of the rock; the customary unit of measurement is the millidarcy. The term “relatively permeable” is defined, with respect to formations or portions thereof, as an average permeability of 10 millidarcy or more (for example, 10 or 100 millidarcy). The term “relatively low permeability” is defined, with respect to formations or portions thereof, as an average permeability of less than about 10 millidarcy.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gauge pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

As used herein, a “reservoir” is a subsurface rock or sand formation from which a production fluid, or resource, can be harvested. The rock formation may include sand, granite, silica, carbonates, clays, and organic matter, such as oil, gas, or coal, among others. Reservoirs can vary in thickness from less than one foot (0.3048 m) to hundreds of feet (hundreds of m). The resource is generally a hydrocarbon, such as a heavy oil impregnated into a sand bed.

In embodiments described herein, a “serpentine well” is a new type of in-fill well. An in-fill well is a well drilled between producing wells for the purpose of more efficient recovery of petroleum from the reservoir. The serpentine wells are directionally drilled to intercept accumulations of unswept hydrocarbons in a reservoir, for example, in an oil sands reservoir. In some embodiments, these accumulations of unswept hydrocarbons may be present underneath the existing wells and, thus, the serpentine wells may underlie current wells, such as steam assisted gravity drainage (SAGD) well pairs.

As discussed in detail above, “Steam Assisted Gravity Drainage” (SAGD), is a thermal recovery process in which steam, or combinations of steam and solvents, is injected into a first well to lower a viscosity of a heavy oil, and fluids are recovered from a second well. Both wells are generally horizontal in the formation and the first well lies above the second well. Accordingly, the reduced viscosity heavy oil flows down to the second well under the force of gravity, although pressure differential may provide some driving force in various applications.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used herein, “thermal recovery processes” include any type of hydrocarbon recovery process that uses a heat source to enhance the recovery, for example, by lowering the viscosity of a hydrocarbon. These processes may use injected mobilizing fluids, such as hot water, wet steam, dry steam, or solvents alone, or in any combinations, to lower the viscosity of the hydrocarbon. Such processes may include subsurface processes, such as cyclic steam stimulation (CSS), cyclic solvent stimulation, steam flooding, solvent injection, and SAGD, among others, and processes that use surface processing for the recovery, such as sub-surface mining and surface mining. Any of the processes referred to herein, such as SAGD may be used in concert with solvents.

A “wellbore” is a hole in the subsurface made by drilling or inserting a conduit into the subsurface. A wellbore may have a substantially circular cross section or any other cross-sectional shape, such as an oval, a square, a rectangle, a triangle, or other regular or irregular shapes. As used herein, the term “well,” when referring to an opening in the formation, may be used interchangeably with the term “wellbore.” Further, multiple pipes may be inserted into a single wellbore, for example, as a liner configured to allow flow from an outer chamber to an inner chamber.

### Overview

Current techniques for harvesting heavy oils may bypass a substantial amount of hydrocarbon resources in the reservoir. The location and quantity of resources, or unswept hydrocarbons, bypassed by the current recovery processes is a function of several factors. These include geologic variability, well placement decisions, operational decisions, and well failures, among others. For example, the current industry practice for well pairs used for steam assisted gravity drainage (SAGD) is to keep the well trajectories as flat as possible, in order to minimize the risk of steam, or other mobilizing fluids, from crossing over to the production well at a high point along a trajectory. Thus, the SAGD wells may bridge low points in a reservoir without accessing the hydrocarbons present. Similarly, the current approaches to using in-fill wells to recover bypassed hydrocarbons use horizontal wells placed between SAGD well pairs, wherein the horizontal wells are kept to flat trajectories for essentially the same reasons.

Embodiments described herein relate to a method for improving recovery from a subsurface hydrocarbon reservoir in which previously a gravity drainage dominated recovery process was applied. Regions are identified within the reservoir that may contain significant accumulations of unswept hydrocarbons. Serpentine wells can then be designed to pass through the regions. The placement and completion of the serpentine wells is optimized to maximize the recovery of the unswept hydrocarbons. For example, the serpentine wells may be completed slightly above a base of the reservoir. As noted herein, the base of the reservoir represents a practical lower limit of the hydrocarbons that may be recoverable by a gravity assisted process.

Fluid communication can then be established between the new serpentine wells and the current swept region of the reservoir. In embodiments, various techniques are used to prevent excess reproduction of injected mobilizing fluids used to in the hydrocarbon recovery process. These techniques may include process design and control, the selective obstruction of portions of the liner in the serpentine wells, or the retirement of existing production wells. In some embodiments, a geometric pattern may be used for placing the in-fill wells.

In various embodiments, the serpentine wells may be steered through the reservoir regions with the largest quantity of by-passed hydrocarbon. Further, the techniques do not necessarily utilize a geometric well pattern for placing the serpentine wells in the reservoir. Additionally, in contrast to previously used in-fill wells, the serpentine wells may replace, rather than supplement, the existing producing wells.

Although, for simplicity of explanation, SAGD is used to describe the techniques herein, the techniques are equally applicable to all recovery processes in which gravity drainage is the dominant recovery mechanism. For example, in an embodiment, a serpentine well may be completed into a reservoir to recover hydrocarbon bypassed during a steamflood recovery process. Further, the techniques may be used in recovery processes that use solvent, or steam and solvent mixtures, to mobilize hydrocarbons. Thus, the injected mobilizing fluid used to harvest the hydrocarbons may include steam, solvents, gas, steam and solvent mixtures, and any combinations thereof, including different mobilizing fluids at different points in the life of a reservoir.

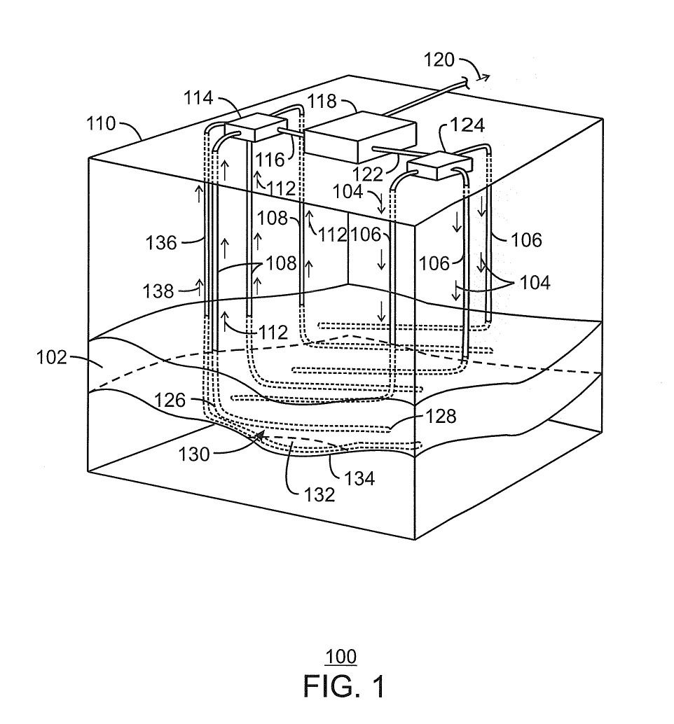

FIG. 1 is a drawing of a SAGD process 100 used for accessing hydrocarbon resources in a reservoir 102. In the SAGD process 100, steam 104 can be injected through injection wells 106 to the reservoir 102. As previously noted, the injection wells 106 may be horizontally drilled through the reservoir 102. Production wells 108 may be drilled horizontally through the reservoir 102, with a production well 108 underlying each injection well 106. Generally, the injection wells 106 and production wells 108 will be drilled from the same pad at the surface 110. This may make it easier for the production well 108 to track the injection well 106. In the illustration in FIG. 1, the wells 106 and 108 are shown as entering the surface 110 from different points to make the flows of materials easier to visualize.

The injection of steam 104 into the injection wells 106 may result in the mobilization of hydrocarbons, which may drain to the production wells 108 and be removed to the surface 110 in a mixed stream 112 that can contain hydrocarbons, condensate and other water, gases, and other materials. Sand filters may be used with the production wells 108 to prevent sand entrainment.

The mixed stream 112 may be pumped to a pumping station 114 that can combine the mixed streams 112 from a number of production wells 108 and send the combined stream 116 to a processing facility 118. At the processing facility 118, the water and hydrocarbons can be separated, and the hydrocarbons 120 sent on for further refining. The resulting water stream 122 may be recycled to a steam generation facility 124, with or without further treatment, and used to generate the steam 104 used for the SAGD process 100.

The production wells 108 may have a segment that is relatively flat, and in some circumstances have a slight upward slope from the heel 126, at which the pipe branches to the surface, to the toe 128, at which the pipe ends. When present, an upward slope of this horizontal segment 130 may result in the toe 128 being around one to five meters higher than the heel 126, depending on the length of the horizontal segment 130. When present, the slight slope assists in draining fluids that enter the horizontal segment 130 to the heel 126 for removal. However, the configuration of the production well 108 can result in bridging over some sections 132 of the reservoir 102, leaving hydrocarbons behind. These sections 132 can be caused by natural variations, or rugosity, in the base 134 of the reservoir, for example, caused by karsting, depositional facies, and erosional incisements.

In an embodiment, the unswept resources in these sections 132 may be accessed using serpentine wells 136. The serpentine wells 136 can be directionally drilled to follow the base 134 of the reservoir 102, for example, moving laterally and vertically towards and through the sections 132. The serpentine wells 136 can be in fluid communication with the steam chambers from the injection wells 106, allowing the serpentine wells 136 to remove a second mixed stream 138 from the reservoir 102. This second mixed stream 138 may be combined with the mixed streams from the remaining active production wells 108 and sent to the processing facility 118. The configuration discussed above is merely used to explain the concepts. Any number of other processes, configurations, or recovery processes using gravity may be used in embodiments. For example, in an embodiment, the current techniques may be used to harvest methane in a coal bed, or reservoir, lying underneath an impermeable cap rock. In this case, a normal fracturing and recovery well may be completed through the center of the coal bed. After production falls from the normal recovery well, a serpentine well may be drilled at the top of the reservoir, following the contours of the cap rock to reached hydrocarbons trapped in pockets at the top of the reservoir. The drilling of the serpentine wells 136 in relation to the previous wells is explained in further detail in the following figures.

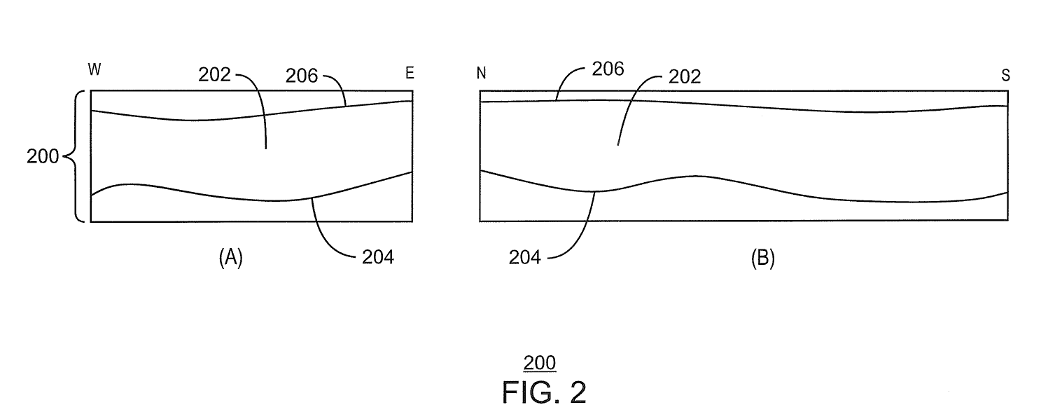

FIGS. 2(A) and (B) are East-West and North-South cross-sections of a portion of a geologic deposit 200, respectively. The geologic deposit 200 may contain a pay zone or reservoir 202. In these cross-sections the base 204 and top 206 of the reservoir 202, denote the range that may be acceptable for exploitation by a SAGD process.

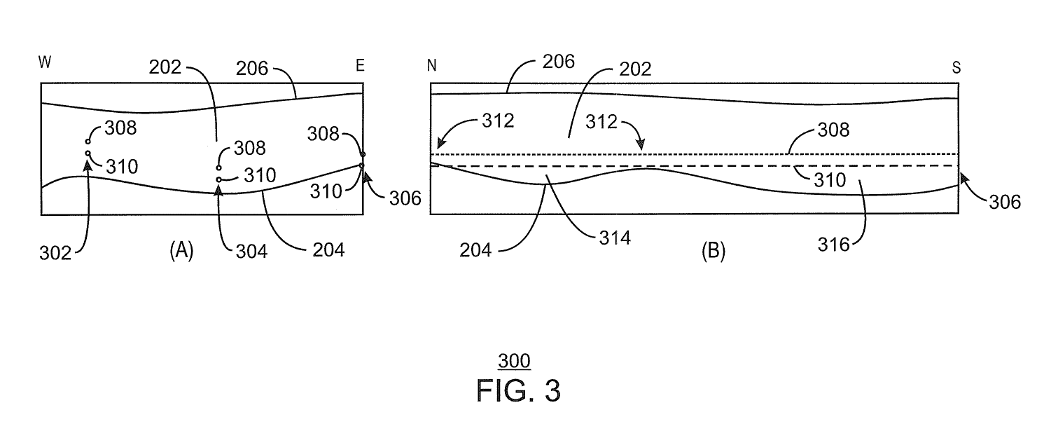

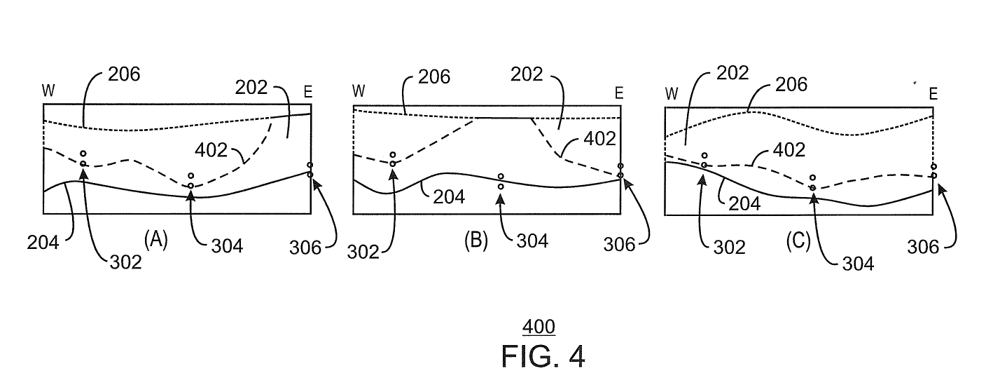

FIGS. 3(A) and (B) are the cross sectional views of the geologic deposit 200 of FIG. 2, with the addition of three SAGD well pairs 302, 304, and 306, each well pair nominally 100 meters (300 feet) from its neighbour. Like numbered items are as discussed in FIG. 2. Each SAGD well pair 302, 304, and 306 includes an injection well 308 and a production well 310, which are generally vertically stacked and separated by 3-10 meters (10 to 30 feet). As commercial SAGD well pairs have horizontal sections that are typically 500-1500 meters (1,500 to 4,500 feet) in length, the conventional approach is to place the depth of the production well 310 as low as possible in the reservoir 202 while still ensuring that the majority of its trajectory stays above the base 204. This can be seen more clearly in FIG. 2(B), which shows one SAGD well pair 306. It can be noted that the figures herein represent only the completion intervals of the wells, as is customary. The production well 310 of the SAGD well pair 306 in FIG. 2(B), contacts the base 204 in two locations, setting the depth of the SAGD well pair 306 in the reservoir 202. However, it can be seen that some regions 314 and 316 may not be adequately accessed by this location, leaving unswept hydrocarbons. This may be further understood by looking at more detailed cross sectional views, such as of a northern portion, middle portion, and southern portion of the North-South cross sectional view of FIG. 2(B). These cross sectional views are discussed further with respect to FIG. 4. It can be noted that the northern portion is also shown in FIG. 3(A).

FIGS. 4(A), (B), and (C) are East-West cross-sectional views 318, 320, of the geologic deposit, representing the northern, middle and southern portions of the North-South cross sectional view of FIG. 3(B). Like numbered items are as discussed in FIGS. 2 and 3. Some reference numbers have been omitted to simplify the figure. The amount of hydrocarbon remaining in the reservoir 202 is shown by a dotted line 402 representing depletion of the reservoir 202 at a point in time when ˜40% of the oil present has been recovered. The non-symmetrical depletion 402 within the reservoir 202 can be a result of geologic variability. Further, portions of the SAGD well pairs 302, 304, and 306 may intercept regions of poorer quality reservoir along their trajectory that are not amendable to recovery using the SAGD process. This poorer quality reservoir may also be referred to as non-pay. Generally, the non-symmetrical depletion 402 may often be seen in devices used to monitor the recovery process, such as time lapse 3D seismic.

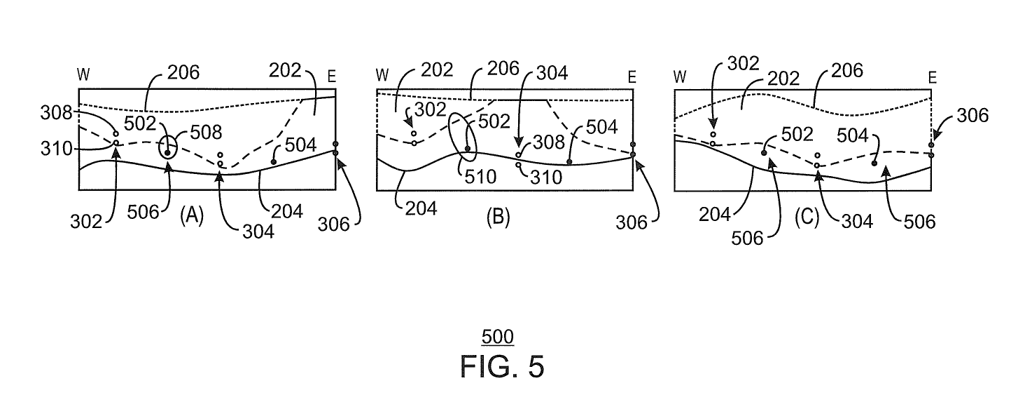

FIGS. 5(A), (B), and (C) are cross-sectional views illustrating the placement of two standard in-fill wells 502 and 504 in the cross-sectional view of FIGS. 4(A), (B), and (C). Like numbered items are as discussed in the previous figures. Some reference numbers have been omitted to simplify the figure. In this example, the in-fill wells 502 and 504 are drilled horizontally through the reservoir 202 with a minimal vertical shift. Thus, the in-fill wells 502 and 504 may still miss portions 506 of the reservoir 202 containing substantial accumulations of bypassed hydrocarbon.

Having open completions along the entire length of the trajectory of the in-fill wells 502 and 504 may also result in the rapid establishment of fluid communication with a depleted region in which the thickness of unswept reservoir isolating the in-fill well 502 or 504 from the swept region is thinnest, for example, as indicated by reference number 508. As a result, it may be more difficult to establish fluid communication between the in-fill well 502 or 504 and the swept region where the unswept reservoir isolating the in-fill well is the thickest, for example, as indicated by reference number 510. This design limitation can be detrimental to the ability of an in-fill well 502 or 504 to maximize economic recovery of the bypassed resource.

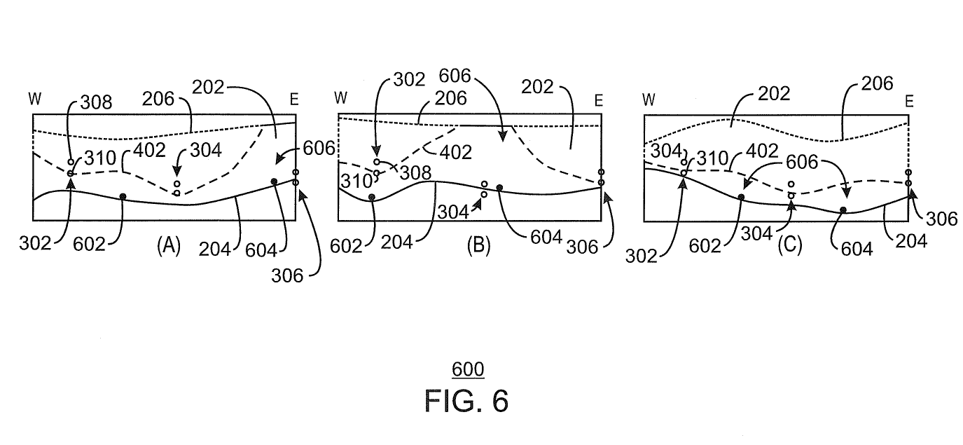

FIGS. 6(A), (B), and (C) are cross-sectional views illustrating the placement of serpentine wells 602 and 604 in the cross-sectional view of FIGS. 4(A), (B), and (C), respectively. Like numbered items are as discussed in the previous figures. Some reference numbers have been omitted to simplify the figure. In this example, the trajectories of the serpentine wells 602 and 604 have been planned based, for example, on a geologic model and an available time lapse 3D seismic monitoring data. Accordingly, the paths of the serpentine wells 602 and 604 intercept the thickest accumulations of bypassed resource 606 within the development. In an embodiment, the serpentine wells may be drilled into the reservoir when at least 50% of the hydrocarbon resource has been recovered. In other embodiments, the serpentine wells can be drilled into the reservoir when at least 40%, at least 30%, at least 20%, or at least 10% of the resource has been recovered. The selection of the point to begin the completion of serpentine wells to the reservoir depends on the amount of resource that can be practically recovered using the previous recovery techniques. For example, in a reservoir formation have a rough base, forming substantial numbers of pockets, the serpentine wells may be drilled sooner, such as when about 10-20% of the resource has been recovered.

Fluid communication can be established between the new serpentine wells 602 and 604 and the existing depleted region of the reservoir 202, indicated as the area above the depletion line 402, by any number of stimulation techniques. For example, cyclic injection of steam, gases, solvent, water or combinations. Other techniques that may be used include continuous injection of steam, gases, solvent, water, or combinations, and circulation of hot fluids, such as steam. Selection of the most appropriate stimulation technique or combinations of stimulation techniques can be made on the basis of geological considerations, as well as the distance between the new well and the existing depleted region.

Once fluid communication is established between the new well and the existing depletion interval, the serpentine wells 602 and 604 can be converted to continuous production. Production rates may be controlled in order to minimize the co-production of the injectant used to mobilize the hydrocarbon. Depending on whether the injectant is steam, a steam-gas mixture, a steam-solvent mixture, solvent or gas, procedures for controlling the co-production of injectant can involve monitoring the bottom hole temperature, bottom hole pressure, or the production rates of injectant observed at surface. These control measures may be estimated from various measurements, models, or combinations. Further, these control measures can be modified to reflect changes in the injectant type and composition that may occur over the life of the project. In addition, the liner could be completed with inflow control devices, such as created by including only a limited number of entry points into the production casing located beneath a sand retention screen, in order to restrict the production of injectant vapour.

Where more than one unswept portion of the reservoir 202 is accessed by the new well, through the use of inflow control devices it may be possible to establish fluid communication between several unswept areas and the swept regions at the same time. It may be advantageous to sequentially deplete each unswept region in turn, with the openings of the inflow control devices along the remaining portions of the trajectory being temporarily obstructed to prevent inflow. Further, as each new section is opened, the previous section could remain open or be obstructed, depending on the specific circumstances present.

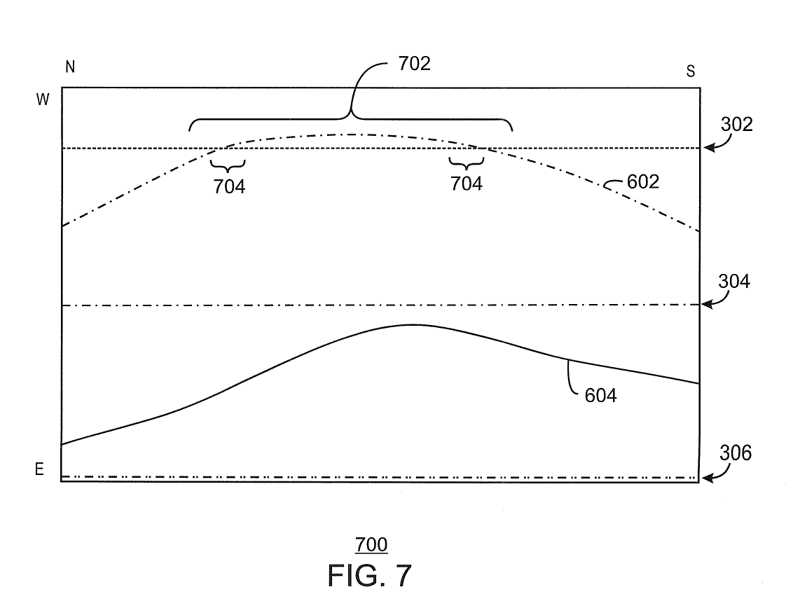

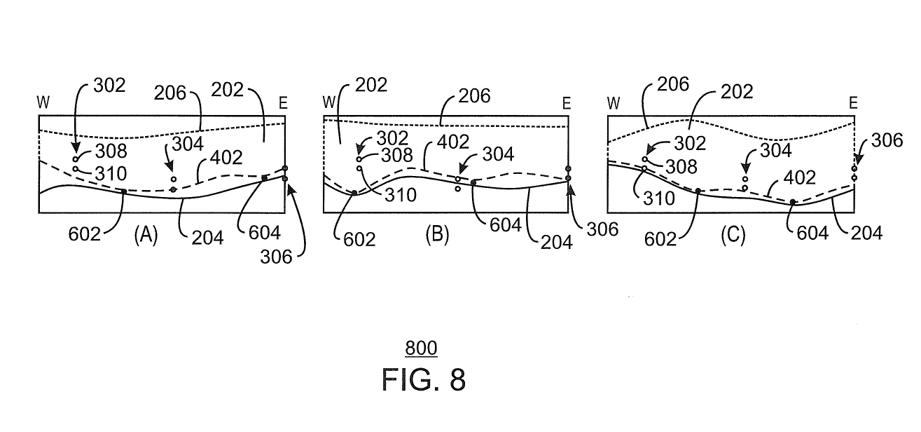

FIG. 7 is top view of the reservoir 202 illustrating the trajectories of the serpentine wells 602 and 604 as they access the bypassed hydrocarbons in the unswept regions. Like numbered items are as discussed in the previous figures. Some reference numbers have been omitted to simplify the figure. In contrast to previous techniques, such as discussed with respect to FIG. 5, one of the serpentine wells 602 passes beneath one of the SAGD well pairs 302. In an embodiment, the production well 310 of the SAGD well pair 302 may be completely blocked in or plugged, allowing the serpentine well 602 to produce hydrocarbons from that area. In another embodiment, a portion of the openings on the production well 310, for example, overlying the serpentine well 602, may be plugged off. This may be performed, for example, by using a liner along a region 702. Thus, the serpentine well 602 may then produce hydrocarbon from the region 702 where the serpentine well 602 crosses under the production well 310. The distance along which the openings in the production well 310 are to be plugged may be determined by geologic and seismic modeling. In some embodiments, the geologic and seismic modeling may indicate that openings in multiple regions 704 of the production well 310 in the SAGD well pair 302 should be plugged. In some embodiments, a production well 310 that is no longer in use may be converted to steam injection service. For example, this may be useful if the injection well 308 in the SAGD well pair 302 that overlies the serpentine well 602 becomes damaged or blocked. One of the reasons for blocking a portion of a production well 310 is discussed further with respect to FIG. 8.

FIGS. 8(A), (B), and (C) are cross-sectional views illustrating the continued growth of the depleted resource in the cross-sectional views of FIGS. 4(A), (B), and (C), respectively, after the start-up of the serpentine wells. Like numbered items are as discussed in the previous figures. Some reference numbers have been omitted to simplify the figure. The placement of a serpentine well 602 below the production well 310 of a SAGD well pair 302 can eventually cause the level of the hydrocarbon resource, as indicated by reference number 402, to underrun the existing SAGD production well 310 at one or more locations along its trajectory. When this occurs, the current SAGD production well 310 will no longer be an effective producer unless portions of the liner that have been underrun by the depletion zone of the serpentine well 602 are obstructed. The obstructions may prevent the loss of fluids from the production well 310 to the serpentine well 602 and the influx of the injectant into the liner of the production well 310. If the liner obstructions are not successful, the production well 310 will need to be shut-in. However, even though the production well 310 is shut-in for the purposes of active production, the completed interval may still collect draining fluids and allow them to crossflow along the liner to where the serpentine well 602 has underrun the production well 310. The mobilized fluids can then leave the blocked-in production well 310 at this point and be collected and produced by the lower serpentine well 602.

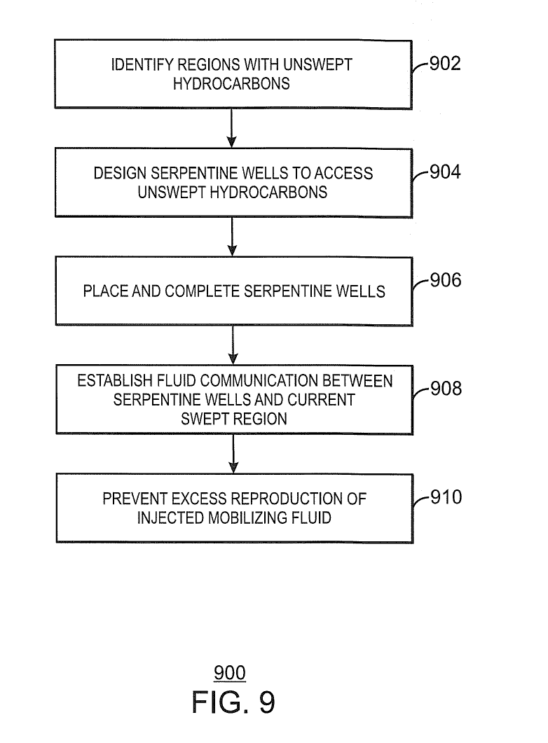

FIG. 9 is a process flow diagram of a method 900 for improving recovery from a subsurface hydrocarbon reservoir using a gravity drainage dominated recovery process. The method 900 starts at block 902 with the identification of regions within the reservoir that may contain significant accumulations of unswept hydrocarbons. This may be performed by a number of techniques. For example, prior to the start of recovery operations, a geologic model can be created for the development area. This geologic model is usually constructed using a geologic modeling software program, such as the Petrel program from Schlumberger, Inc. Available open hole and cased hole log, core, 2D and 3D seismic data, and knowledge of the depositional environment setting can all be used in the construction the geologic model.

The geologic model and knowledge of surface access constraints can then be used to complete the layout of the recovery process wells and surface pads. After the development wells have been drilled, data collected during their drilling as well as data collected during the operation of the recovery process, such as cased hole logs including temperature logs, observation wells, additional time lapse seismic or other remote surveying data, can be used to update the geologic model and to map the evolution of the depletion patterns as the recovery process matures. The depletion patterns within the reservoir will be influenced by well placement decisions, geological heterogeneity, well failures, and day to day operating decisions.

Following the operation of the thermal, thermal-solvent or solvent based recovery process for a suitable period of time, intervals of high hydrocarbon depletion will create a series of discrete connections between adjacent wells or well pairs, depending on the recovery process. Knowledge of these connections is gained through observances of interwell or interpattern communication of fluids, convergence of operating pressures, as well as via ongoing reservoir depletion monitoring with tools such as time lapse 3D seismic.

Before a recovery process has achieved 50% of its anticipated recovery, there may be sufficient data to the identifications of the regions that may have largest accumulations of unswept hydrocarbon. It is unlikely that these unswept areas will occur in a geometrically repeating pattern, and for this reason a geometric pattern of new horizontal wells with flat trajectories, as used in standard in-fill wells, is unlikely to result in the maximization of economic resource recovery.

Thus, at block 904, serpentine wells can be designed using the available geologic model and performance monitoring data. The depth and lateral offset of the trajectories of the serpentine wells vary such that a portion of each serpentine well can intercept one or more of the unswept hydrocarbon intervals near their base.

At block 906, the placement and completion of the new wells can be optimized in relation to the unswept hydrocarbons, in order to maximize the recovery of the unswept hydrocarbons. Where sufficient geologic contrast is present, for example, between an oil sand layer and a lower impermeable rock layer, the new wells can be geosteered. The geosteering may be done by gamma ray detectors, seismic detectors, and any other suitable techniques. The geosteering may help to ensure that the actual well path remains close to the base of the reservoir and in a region that has adequate vertical permeability. This may allow the development of acceptable production rates with the gravity drainage mechanism at the new well. As a result, the trajectory of the serpentine wells may undulate vertically and laterally as they pass through the reservoir interval.

Temperature and induction log data collected during the drilling of new well may be used to confirm the areas along the trajectory of the new well that are either proximal to the existing depleted reservoir, for example, as indicated by elevated temperatures or reduced oil saturation, or more distant, for example, as indicated by low temperature and high oil saturation. These data can be used to guide the completion strategy for the new well, for example, indicating which sections or the serpentine wells should be perforated and which sections should be blocked.

The serpentine wells can be completed such that the portions of the trajectories with open areas exposed to the reservoir are opposite the unswept portions of the reservoir with the coldest temperature or highest induction log signature. For example, these open intervals may generally be located at or below the depth of the production well completions in the offset existing wells in SAGD well pairs. The remaining portions of the trajectories of the serpentine wells can either be completed with blank pipe or have the completions obstructed to prevent in-flow. For example, one such obstruction that can be used is a scab liner that is set inside a production liner.

At block 908, fluid communication can be established between the serpentine wells and the current swept region of the reservoir. Fluid communication can be established between the new well completion and the existing depleted reservoir by one of a number of stimulation techniques. Examples of such stimulation techniques include cyclic injection and production of steam, gas, solvent, or water. Other suitable stimulation techniques can include continuous steam, gas, solvent, or water injection, and the circulation of hot fluids, such as steam. Selection of the most appropriate technique or combination of techniques will be dependent on geological considerations and the distance between the new well and the existing depleted zones.

At block 910, process design and control combined with the selective obstruction of portions of the liner or the retirement of existing production wells can be used to prevent excess reproduction of an injected mobilizing fluid. Once fluid communication is established between the serpentine well and the existing depletion interval, the serpentine well can be converted to continuous production. Production rates may be controlled to help minimize the co-production of the injectant used to mobilize the hydrocarbon. Depending on whether the injectant is steam, a steam-gas mixture, a steam-solvent mixture, solvent or gas, such procedures for controlling the amount of injectant co-production can include monitoring the bottom hole temperature or pressure, as well as the production rates of injectant observed at surface. In addition, the injectant amount and type may also be modified to keep the measurements within control ranges. The control measures can be modified to reflect changes in the injectant type and composition that may occur over the life of the project. In addition, the liner could be completed with inflow control devices to restrict the production of injectant vapour.

Where more than one unswept portion of the reservoir is accessed by the serpentine well, inflow control devices may enable the establishment of fluid communication between more than one unswept area and the swept regions at the same time. In some embodiments, each interval may be sequentially stimulated to establish fluid communication. Further, when more than one unswept portion of the reservoir is accessed by the serpentine well, production from the multiple completion intervals can be produced to surface using a common production string, with the reproduction of the injectant constrained through the use of inflow control devices included as part of each selective completion interval. Alternatively, two or more production strings, located in different low points along the serpentine well trajectory, can be used to produce fluid from the serpentine well. Depending on whether the injectant is steam, a steam-gas mixture, a steam-solvent mixture, solvent or gas, procedures for controlling the co-production of injectant from each production string can involve the monitoring the bottom hole temperature, bottom hole pressure, or the production rates of injectant observed at surface from each individual production string. In some embodiments, each unswept region can be sequentially depleted in turn, with the perforations, screens, or slots along the remaining portions of the trajectory obstructed to prevent flow.

As noted, the lower placement of a serpentine well will cause the depleted resource to eventually underrun one or more existing production wells, for example, in SAGD well pairs, at one or more locations along the trajectory. When this occurs, the current production well may no longer be an effective producer. Accordingly, portions of the liner that have been underrun by the serpentine well's depletion zone can be obstructed or the production liner may be shut-in.

The serpentine wells do not need to be drilled on a repeating geometric pattern, or throughout the development area, to maximize the economic recovery of the hydrocarbon. Instead, in various embodiments, the locations of the unswept hydrocarbon can determine the locations of the serpentine wells. Accordingly, it may possible that some patterns will have no serpentine wells and other patterns may have more than one. In some embodiments, this strategy will result in the trajectory of the serpentine well targeting unswept resource directly below the existing wells. The trajectory of the serpentine well may target unswept resource that can be present at variable offset distances from the existing wells.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for improving recovery from a subsurface hydrocarbon reservoir, the method comprising:
identifying a region within the reservoir that comprises unswept hydrocarbons;
accessing the region by a serpentine well, wherein the placement and completion of the serpentine well is designed to increase the recovery of the unswept hydrocarbons; and
establishing fluid communication between the serpentine well and a swept region of the reservoir.

2. The method of claim 1, comprising minimizing production of an injected mobilizing fluid used in the hydrocarbon recovery process.

3. The method of claim 1, wherein identifying the region comprises:
creating a geologic model of the reservoir; and
using the geologic model to locate the unswept hydrocarbons.

4. The method of claim 3, wherein creating the geologic model comprises collecting open hole log data, cased hole log data, core data, recovery process well trajectories, 2D seismic data, 3D seismic data, or other remote surveying data, or any combinations thereof.

5. The method of claim 1, wherein accessing the region comprises designing the serpentine well with a vertical placement, lateral placement, or both, that changes to intercept the region near a base within the reservoir.

6. The method of claim 1, wherein accessing the region comprises completing the serpentine well so that that openings in the serpentine well are placed in the unswept portions of the reservoir having a coldest temperature, a highest induction log signature, or both.

7. The method of claim 4, comprising completing sections of the serpentine well in warmer regions or having lower induction log signatures with blank pipe or obstructing openings to prevent flow.

8. The method of claim 1, wherein accessing the region comprises geosteering the serpentine well to follow the base of the portion of the reservoir containing resource acceptable for exploitation by the recovery process.

9. The method of claim 2, wherein minimizing production of the injected mobilizing fluid comprises obstructing portions of a liner in the serpentine well.

10. The method of claim 2, wherein minimizing production of the injected mobilizing fluid comprises blocking in a production well.

11. The method of claim 2, wherein minimizing production of the injected mobilizing fluid comprises obstructing portions of a liner in a production well.

12. The method of claim 1, wherein establishing fluid communication comprises cyclic steam injection and production, cyclic solvent injection and production, continuous solvent injection, continuous steam injection, continuous gas injection, continuous water injection, hot steam circulation, or hot fluid circulation, or any combinations thereof.

13. The method of claim 2, where minimizing production of the injected mobilizing fluid comprises:
estimating the bottom hole temperature, the bottom hole pressure, the production rates of the injected mobilizing fluid at the surface, or a combination of these; and
adjusting the production rates, injection rates, or both, of the mobilizing fluid, at least in part, on data estimated.

14. The method of claim 2, wherein minimizing production of the injected mobilizing fluid comprises equipping a liner with inflow control devices to restrict the production of the injected mobilizing fluid.

15. The method of claim 1, comprising accessing each of two or more unswept regions of the reservoir by an associated separate portion of the serpentine well.

16. The method of claim 15, comprising:
sequentially depleting each unswept region through the associated separate portion of the serpentine well; and
blocking the associated separate portion of the serpentine well when it is not used to produce hydrocarbons from the associated unswept region.

17. The method of claim 1, comprising blocking unused perforations of the trajectory of the serpentine well with a scab liner.

18. The method of claim 1, comprising drilling the serpentine well deeper than existing production wells.

19. The method of claim 18, comprising shutting in an existing production wells.

20. The method of claim 18, comprising obstructing a liner in an existing production well for at least a portion of a trajectory.

21. The method of claim 1, comprising drilling the serpentine well once an existing recovery process has achieved at least 50% of its anticipated recovery.

22. The method of claim 1, comprising drilling the serpentine well once an existing recovery process has achieved at least 10% of its anticipated recovery.

23. A system for harvesting bypassed resources in a reservoir, comprising:
a gravity drainage system configured to drain a first portion of resources from a reservoir; and
a serpentine well, wherein the serpentine well is directionally drilled to follow a base of the reservoir, wherein the base substantially delineates the resources that are recoverable, and wherein the serpentine is configured to harvest a second portion of resources from the reservoir.

24. The system of claim 23, wherein the gravity drainage system comprises a plurality of steam assisted gravity drainage (SAGD) well pairs drilled in a substantially horizontal fashion through the reservoir.

25. The system of claim 23, wherein the gravity drainage system comprises a plurality of steamflood wells.

26. The system of claim 23, where in the gravity drainage system comprises a plurality of mature cyclic steam stimulation (CSS) wells.

27. The system of claim 23, wherein the gravity drainage system comprises a plurality of injectant-assisted gravity drainage well pairs drilled in a substantially horizontal fashion through the reservoir, wherein the injectant comprises a solvent, steam, hot water, or any combinations thereof.

28. The system of claim 23, wherein the gravity drainage system comprises a plurality of injectant wells, wherein the injectant comprises a solvent, steam, hot water, gas, or any combinations thereof.

29. The system of claim 23, where in the gravity drainage system comprises a plurality of mature cyclic stimulation wells, wherein an injectant is used to mobilize the resources, and wherein the injectant comprises a solvent, steam, hot water, or any combinations thereof.

30. The system of claim 23, wherein the serpentine well is geosteered during drilling.

31. The system of claim 23, wherein perforations in a trajectory of a production well in the gravity drainage system that overlies the serpentine well is plugged.

32. The system of claim 23, wherein the serpentine well is directionally drilled to access a plurality of regions comprising bypassed hydrocarbons.

33. The system of claim 23, wherein perforations in a trajectory of the serpentine well are blocked when not used to harvest the second portion.

34. The system of claim 23, comprising a geologic model configured to identify the second portion.

35. A method for drilling a well in a reservoir, comprising:
planning a well trajectory for a serpentine well that accesses a bypassed hydrocarbon in the reservoir;
drilling the serpentine well using lateral displacements and vertical displacements to follow a base of a payzone in the reservoir; and
completing the serpentine well with perforations in regions comprising the bypassed hydrocarbon.

36. The method of claim 35, comprising collecting open hole log data, cased hole log data, core data, recovery process well trajectories, 2D seismic data, 3D seismic data, or other remote surveying data, or any combinations thereof.

37. The method of claim 36, comprising constructing a geologic model from the data collected.

38. The method of claim 35, comprising identifying well trajectories that need to be blocked to minimize production of injected mobilizing fluids.

39. The method of claim 35, comprising identifying productions wells that need to be partially or fully blocked to minimize production of injected mobilizing fluids.
